(19) United States
(12) Patent Application Publication
(10) Pub. No.: US 2011/0000345 A1
(43) Pub. Date: Jan. 6, 2011

(54) SINGLE-BIT RETRACTABLE SCREWDRIVER

(75) Inventor: Gary Paul CLUTHE, Waterloo (CA)

Correspondence Address: BORDEN LADNER GERVAIS LLP;Anne Kinsman, WORLD EXCHANGE PLAZA, 100 QUEEN STREET SUITE 1100, OTTAWA, ON, K1P 1J9, CA

(73) Assignee: DURON PLASTICS LIMITED, Waterloo (CA)

(21) Appl. No.: 12/826,944

(22) Filed: Jun. 30, 2010

Related U.S. Application Data
(60) Provisional application No. 61/222,508, filed on Jul. 2, 2009.

(51) Int. Cl. B25B 15/00; B25B 23/16

(52) U.S. Cl. 81/436; 81/177.1

(57) ABSTRACT

A single-bit screwdriver comprising: a housing; a shaft slideably mounted in the housing; the shaft having a locking portion, and the housing having at least two locking mechanism, wherein each locking mechanism engages the locking portion to prevent sliding of the shaft relative to the housing.

### CROSS-REFERENCE

The present application claims the benefit of U.S. provisional patent application No. 61/222,508, filed Jul. 2, 2009, which is incorporated herein by reference.

### FIELD

The present application relates generally to hand tools. More particularly, the present application relates to a single-bit screwdriver with an extendable and retractable shaft.

### BACKGROUND

Conventional screwdrivers have a fixed shaft length. However, the placement and configuration of screws often results in a need for different shaft lengths. Keeping multiple sets of screwdrivers with various shaft lengths increases the cost, weight, and storage required for a set of tools. Moreover, screwdrivers with long shaft lengths can be cumbersome to store and carry.

There is a need for a screwdriver to have an extendable and retractable shaft in order to be used in at least two configurations. There is a further need for an extendable and retractable screwdriver to be user friendly and retract to a convenient size for maneuvering and storage.

### SUMMARY

There is provided a single-bit screwdriver comprising a housing; a shaft slideably mounted in the housing, the shaft having a locking portion, and the housing having at least two locking mechanisms, wherein each locking mechanism engages the locking portion to prevent sliding of the shaft relative to the housing in at least two operable positions.

In another aspect, there is provided a single-bit screwdriver comprising: a housing; a shaft slideably mounted in the housing; the shaft having a locking portion designed to engage a locking tab at one end of the housing and a locking mechanism at a second end of the housing wherein the locking mechanism and the locking tab engage the locking portion to prevent sliding of the shaft relative to the housing in two operable positions.

Other aspects and features of the present application will become apparent to those ordinarily skilled in the art upon review of the following description of specific embodiments in conjunction with the accompanying Figures.

### BRIEF DESCRIPTION OF THE DRAWINGS

Embodiments of the present application will now be described, by way of example only, with reference to the attached Figures, wherein:

FIG. 1 is an exploded perspective view of an embodiment of a single-bit screwdriver;

FIG. 2 is a cross section view of an exploded perspective view of an embodiment of the single-bit screwdriver;

FIG. 3 is a cross-section view of an embodiment of the single-bit screwdriver in a retracted position;

FIG. 4 is a cross-section view of an embodiment of the single-bit screwdriver in an extended position;

FIG. 5 is cross-section view of an embodiment of the single-bit screwdriver in an extended position with the locking mechanism engaged;

FIG. 6 is another cross-section of the single-bit screwdriver in the retracted position;

FIG. 7 is a cross-section of the single-bit screwdriver in the extended position; and

FIG. 8 is a perspective view of another embodiment of a single-bit screwdriver.

### DETAILED DESCRIPTION

Generally, there is provided a single-bit screwdriver with an extendable and retractable shaft that can be locked in two or more positions.

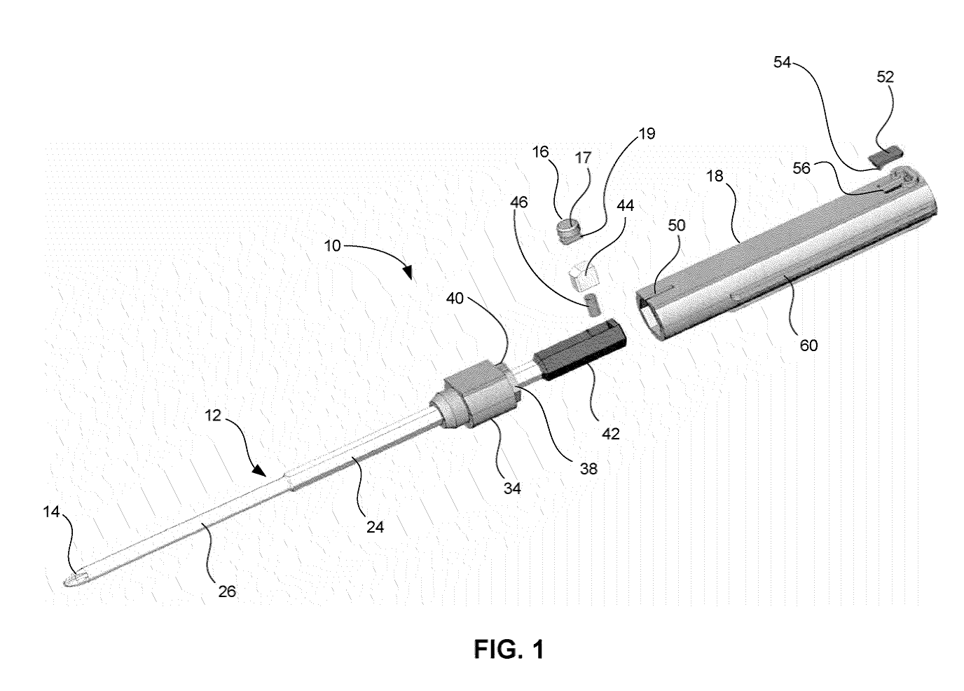

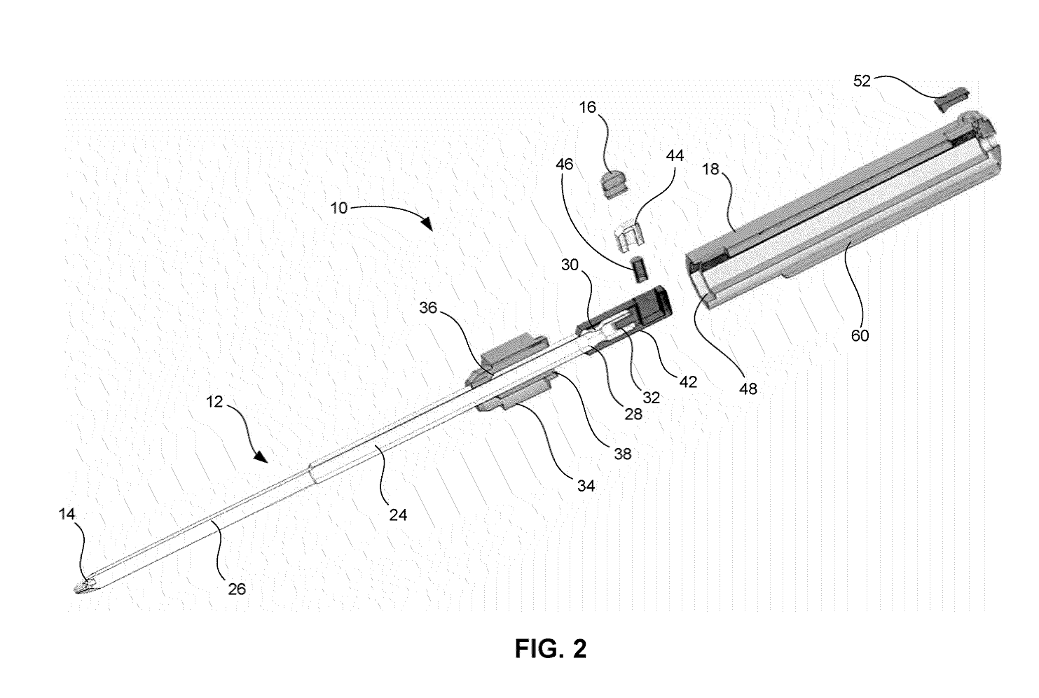

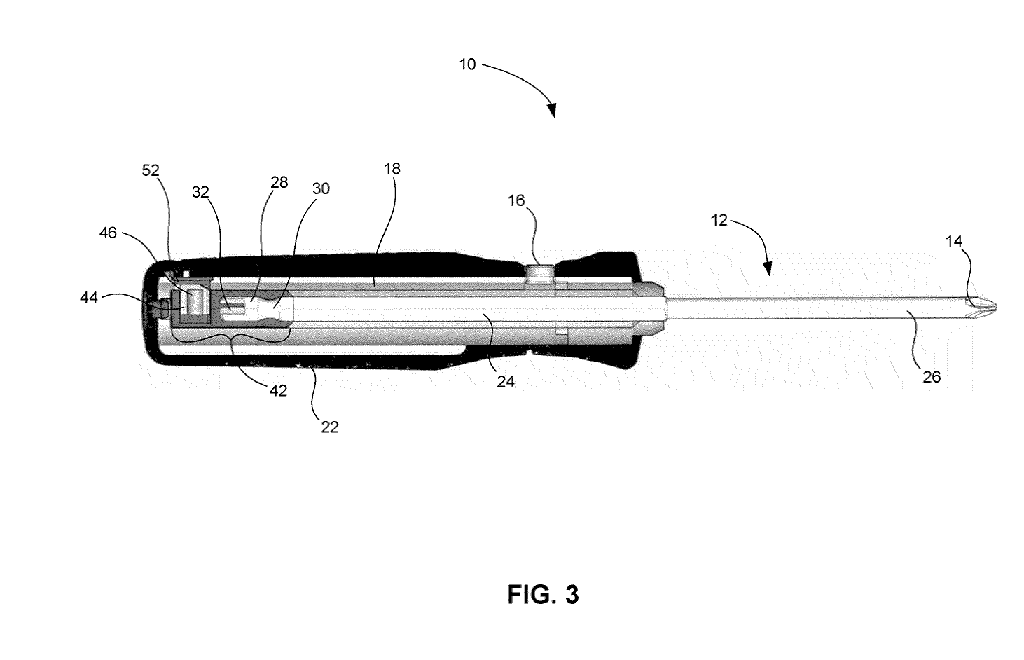

FIGS. 1 and 2 illustrate exploded views of a single-bit screwdriver 10. The screwdriver 10 comprises a shaft 12, which is adapted to be slideably held within a housing 18. A handle portion 22, shown in FIGS. 3 to 5, may cover the housing 18. The handle portion 22 is preferably overmoulded reducing or eliminating the need for screws or other fasteners to hold the handle portion 22 in place with respect to the final product. The handle portion 22 may also be two or more separate pieces that can be attached to enclose the housing 18.

The shaft 12 includes a bit 14 at one end, a fixed extension portion 26 and a slideable extension portion 24. The end 28 of the slideable extension portion 24 may be enclosed within a locking portion 42 creating a further extension of the shaft 12. The end 28 of the slideable extension portion 24 may also include features for securing the locking portion 42 to the end. These features may include a groove 30 or aperture 32 incorporated in the end 28 of the slideable extension portion 24 with which the locking portion 42 may connect to securely hold the shaft 12 in place.

The bit 14 can be any one of a variety of screwdriver bit types, such as slotted, crosshead (Phillips), square, Allen, etc., and integral or otherwise attached to the fixed extension portion 26. In an alternative embodiment of the single-bit screwdriver, the single-bit retractable screwdriver comprises a bit holder for receiving removable tool bits. In the current embodiment, the slideable extension portion 24 and the housing 18 have hexagonal cross-sections, and are dimensioned to fittingly correspond to each other to allow the slideable portion 24 to smoothly slide through the housing 18 between positions. The hexagonal cross sections reduce or prevent rotation of the shaft 12 relative to the housing 18, and assist in transmitting the torque generated by rotating the handle 22 to the bit 14. It will be understood that other cross-sectional shapes for the slideable extension portion 24 and the housing 18 can be used to the same effect.

In FIGS. 1 and 2, some of the internal components of the screwdriver 10 are shown, such as a locking mechanism 16 and the locking portion 42. The locking mechanism 16 may resemble a button or tab on its exposed portion 17 and its unexposed 19 or bottom portion assists to restrain or retain the shaft 12 in place, allowing the screwdriver to be operable in an extended position. The unexposed portion of the locking mechanism 16 may be designed to engage a recess or slot 50 within the housing 18, or may be inserted into the housing through an aperture or other design. The locking mechanism 16 may become depressible by a user once it is engaged by the locking portion 42.

The locking portion 42 further comprises a plunger 44 and an activator 46. The plunger 44 may include an angled top surface. The activator 46 may be made of a bias, a spring or a compressible material. In the extended position, the activator 46 presses against the plunger 44, which in turn engages the locking mechanism 16. As the locking mechanism 16, once engaged, is pushed into a depressible position, the plunger 44 becomes locked within the housing 18, and protrudes from the locking portion 42.

Depressing the locking mechanism 16 will compress the activator 46 and push the plunger 44 to a position level with the perimeter of locking portion 42, thus allowing the shaft 12 to be slid through the housing 18 to another position such as the operable retracted position. In an alternative embodiment, the activator and plunger may be an integrated component, made of compressible material.

The housing 18 may be connected to a block 34 which has a tapered hollow portion 36 designed to receive the slideable extension portion 24. The block 34 serves to abut against the locking portion 42 so that the screwdriver may not be dismantled or disassembled even if the locking mechanism 16 were to fail or break. Preferably, the locking portion 42 may also be tapered at the end that abuts the tapered hollow 36 to match the profile of the block 34.

The block 34 may further comprise a recessed area 38 designed to engage a corresponding area 48 in the housing 18. The recessed area 38 may further include a protrusion 40 designed to fit the slot 50 allowing for the internal components to be seated within the screwdriver 10. It will be understood that for the overmoulding process for the handle portion 22, a seal is preferred to reduce the chance that the overmoulded material will enter into the housing or screwdriver and hinder use of the screwdriver. The housing 18 may further comprise elongated protrusions 60 or other overmoulding features to set and center the internal components for the overmoulding process.

The screwdriver 10 may further comprise a second locking mechanism or locking tab 52 at the back end of the housing 18. The locking tab 52 may include an angled bottom surface or angled protrusion 54 corresponding to the angled surface of the plunger 44. Alternatively, the locking tab 52 may be a radial surface with sufficient incline or ramp to force the activator to compress when the shaft is slid out from the retracted position. The locking tab 52 frictionally retains the plunger 44, which allows the shaft to remain in the retracted position. The locking tab 52 may be integrated into the hollow housing 18 or may be a separate piece designed to fit within an aperture 56 in the housing 18.

When a user wishes to change the position of screwdriver from the retracted position to the extended position, the user may slide the shaft outwardly, the force of the sliding causes the plunger 44 to overcome the frictional hold of the locking tab 52. The shaft will slide through the housing 18 until the plunger 44 engages the locking mechanism 16.

FIG. 3 illustrates the screwdriver in the operable retracted position. In this position the plunger 44 is frictionally held in place by the locking tab 52. The activator 46 is held in a compressed form within the housing 18.

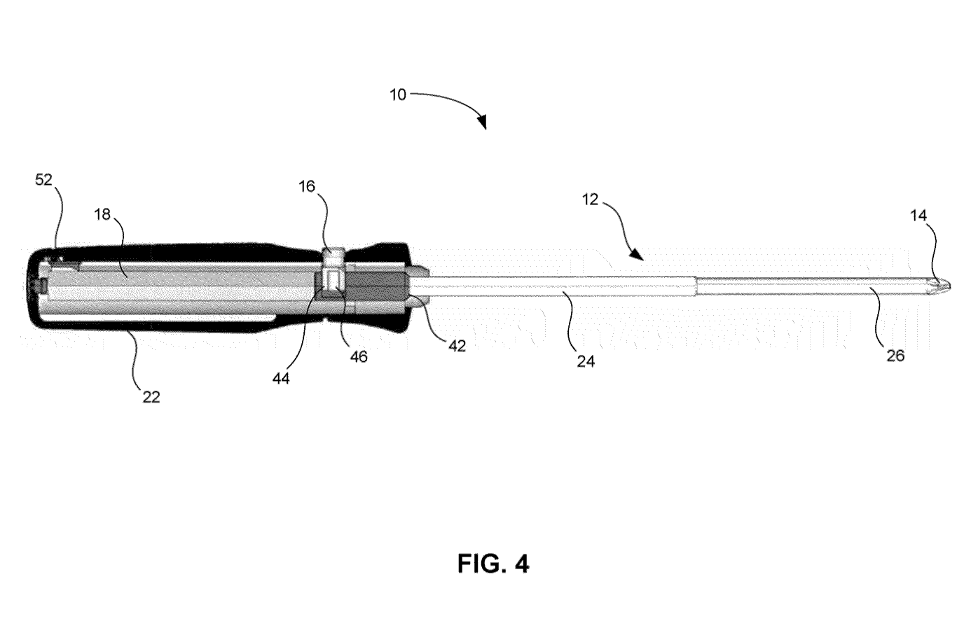

FIG. 4 illustrates the screwdriver in an extended position. In reaching the extended position, the slideable extension portion 24 may be slid through the housing 18 until the locking portion 42 engages the locking mechanism 16.

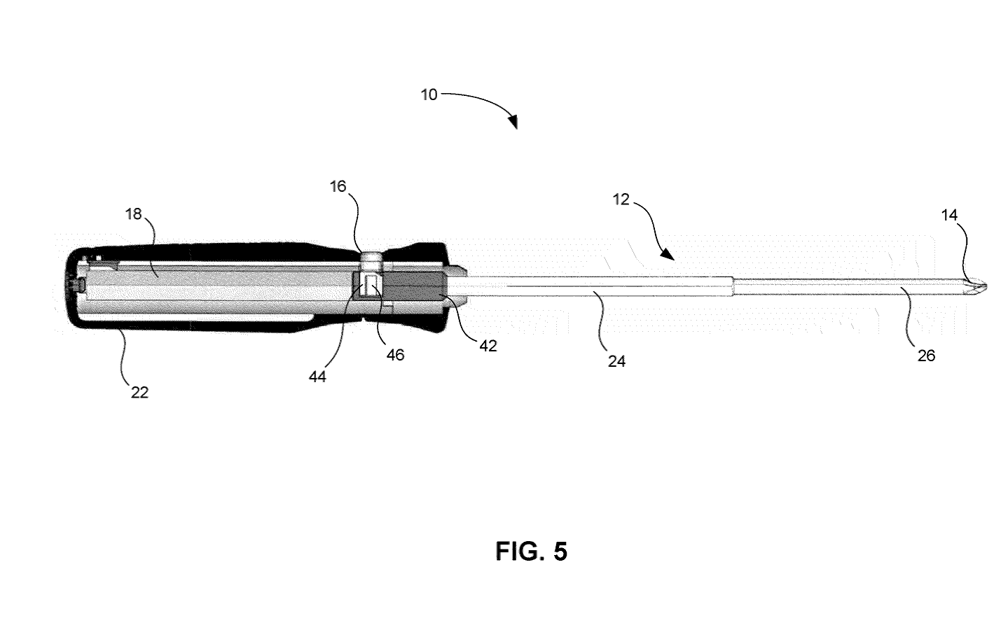

Once the locking mechanism 16 is engaged by the locking portion 42, the engaged locking mechanism 16 will become depressible by a user. The user may depress the locking mechanism 16, unlocking the locking portion 42, as shown in FIG. 5. Once the locking mechanism 16 is depressed, the locking portion 42 will become disengaged and the user may then slide the shaft to the operable retracted position or any intermediate position.

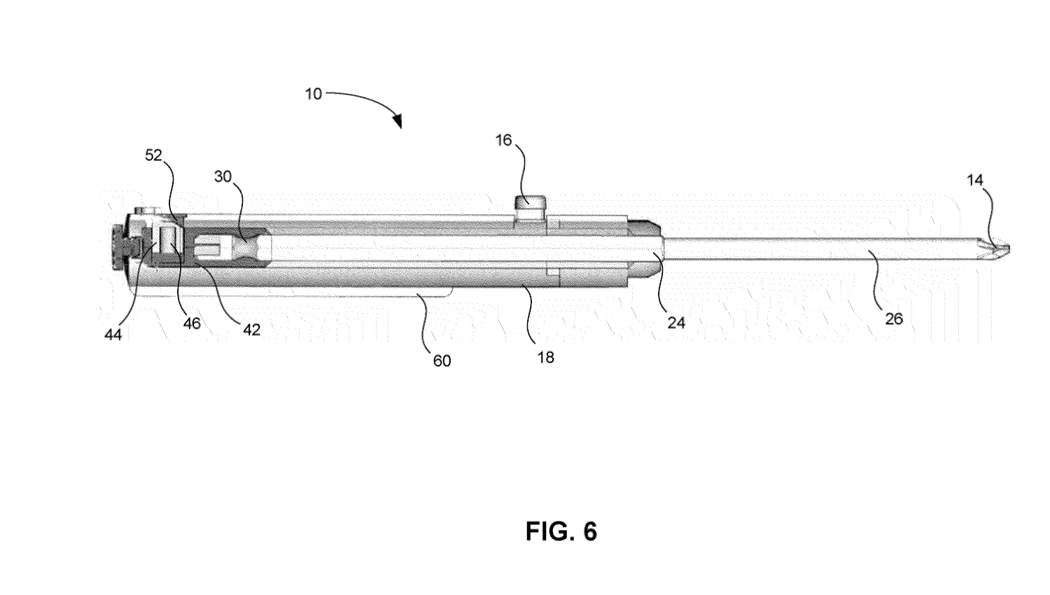

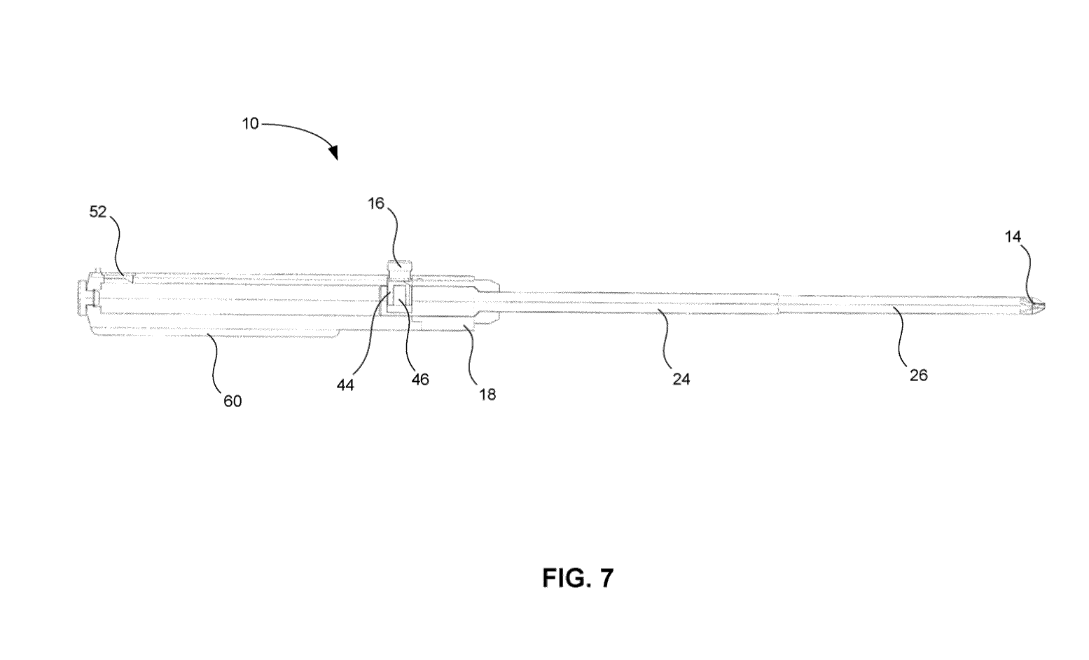

FIG. 6 shows a cross section of the screwdriver in the operable retracted position prior to being fitted with the handle portion. FIG. 7 illustrates a cross section of the screwdriver in the operable extended position wherein the fixed extension portion 26 comprises a hexagonal cross section. From these cross-sectional figures, the locking tab 52 and locking mechanism 16 are each viewable in their locked and unlocked position. FIG. 6 illustrates the frictional lock the locking tab 52 may exert on the plunger 44. FIG. 7 shows the locking tab disengaged and the locking mechanism 16 engaged through the expansion of the activator 46 within the plunger 44.

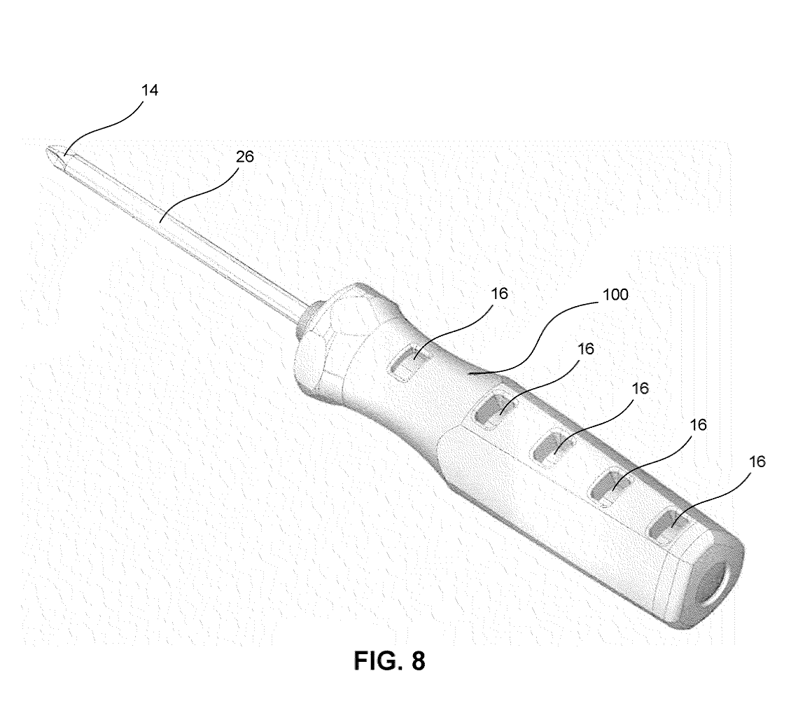

FIG. 8 further illustrates an alternative embodiment of the screwdriver with multiple locking positions. In this embodiment, the housing 18 may be equipped with a plurality locking mechanisms 16 along one side of the housing. Once the shaft travels through the housing, the locking portion 42 may engage each of the plurality of locking mechanisms 16. Once the plunger of the locking portion engages a locking mechanism 16, the locking mechanism 16 will become depressible to disengage the plunger and locking portion. When the user depresses the locking mechanism 16, the user can select whether to slide the shaft outward to a further extended position or to retract the shaft to a shorter retracted position. It will be understood the number of locking mechanisms and therefore number of operable positions available may depend on the length of the shaft and the length of the housing. To ensure a comfortable grip of the handle portion, it may be preferred to have only one extended and one retracted operable position.

The above-described embodiments are intended to be examples only. Alterations, modifications and variations can be effected to the particular embodiments by those of skill in the art without departing from the scope of the invention, which is defined solely by the claims appended hereto.

What is claimed is:

1. A single-bit screwdriver comprising:
a housing;
a shaft slideably mounted in the housing;
the shaft having a locking portion, and the housing having at least two locking mechanisms, wherein each locking mechanism engages the locking portion to hold the shaft in one of at least two operable positions

2. The single-bit screwdriver of claim 1 wherein one of the at least two operable positions is a retracted position.

3. The single-bit screwdriver of claim 1 wherein one of the at least two operable positions is an extended position.

4. The single-bit screwdriver of claim 1 wherein the locking portion further comprises a plunger and a compressible activator.

5. The single-bit screwdriver of claim 4 wherein the activator and the plunger are a single integrated component.

6. The single-bit screwdriver of claim 5 wherein the plunger comprises an angled top surface.

7. The single bit screwdriver of claim 6 wherein at least one of the locking mechanisms comprises an angled surface corresponding to the angled top surface of the plunger.

8. The single-bit screwdriver of claim 1 wherein at least one of the locking mechanisms becomes depressible once engaged by the locking portion.

9. The single-bit screwdriver of claim 1 wherein the shaft comprises:
a bit;
a fixed extension portion; and
a slideable extension portion, wherein one end of the slideable extension portion is enclosed within the locking portion.

10. The single-bit screwdriver of claim 9 wherein the slideable extension portion of the shaft further comprises a groove designed to secure the locking portion to the shaft.

11. The single-bit screwdriver of claim 9 wherein the slideable extension portion of the shaft further comprises an aperture designed to secure the locking portion to the shaft.

12. The single-bit screwdriver of claim 1 further comprising a block connected to the housing.

13. The single-bit screwdriver of claim 12 wherein the block comprising a tapered hollow wherein the locking portion is designed to abut against the hollow.

14. The single-bit screwdriver of claim 1 wherein the screwdriver further comprises an overmoulded handle.

15. A single-bit screw-driver comprising:
a housing;
a shaft slideably mounted in the housing;
the shaft having a locking portion designed to engage a locking tab at one end of the housing and a locking mechanism at a second end of the housing wherein the locking mechanism and the locking tab engage the locking portion to prevent sliding of the shaft relative to the housing in two operable positions.

16. The single-bit screwdriver of claim 15 wherein the locking portion further comprises a plunger and a compressible activator.

17. The single-bit screwdriver of claim 15 wherein the shaft comprises:
a bit;
a fixed extension portion; and
a slideable extension portion, wherein one end of the slideable extension portion is enclosed within the locking portion.

18. The single-bit screwdriver of claim 15 wherein the screwdriver further comprises an overmoulded handle.

19. The single-bit screwdriver of claim 15 wherein the locking mechanism becomes depressible once engaged by the locking portion.
